(19) United States
(12) Patent Application Publication
(10) Pub. No.: US 2020/0012919 A1
(43) Pub. Date: Jan. 9, 2020

(54) Generating Predictions of Outcomes of Legal Arguments and Events Using Unstructured Natural Language Data

(71) Applicant: Yavar Bathaee, New York, NY (US)

(72) Inventor: Yavar Bathaee, New York, NY (US)

(21) Appl. No.: 16/030,650

(22) Filed: Jul. 9, 2018

(51) Int. Cl. G06N 3/04; G06Q 50/18

(52) U.S. Cl. CPC G06N 3/0427; G06N 3/08; G06Q 50/18

(57) ABSTRACT

Computer implemented methods and systems are disclosed for obtaining predictions of legal events, such as legal and factual arguments presented to courts, juries or other adjudicative or fact-finding bodies, using machine-learning algorithms, wherein (i) unstructured data, such as natural language text from documents, such as pleadings, briefs or corpuses of evidence are converted into tokens, vectors and/or embeddings; (ii) the machine-learning algorithm(s) are provided the converted unstructured data as inputs; and (iii) the machine-learning algorithms provide confidence or probability scores predicting outcomes of legal events, such as legal proceedings or one or more legal or factual issues to be decided by particular adjudicators, tribunals or fact-finding bodies.

### BACKGROUND

The present disclosure is related to a method and system for determining probability outcomes for legal and factual proceedings and arguments before adjudicators and fact-finders, such as courts, juries, and administrative tribunals, by using, inter alia, unstructured documents containing natural language, such as legal pleadings, to train machine-learning models.

One of the most challenging tasks for a lawyer or a party involved in litigation or a legal proceeding is to determine the probability of overall success in that proceeding as well as the likelihood of succeeding on specific arguments that could be raised. Gauging such probabilities ordinarily requires a lawyer or advocate with extensive experience with particular legal arguments, forms of evidence, tribunals, judges or jury pools. Even when an experienced lawyer or advocate is assessing potential outcomes, he or she may fall prey to biases, including biases arising from his or her recent failures or successes in similar circumstances or from inaccurate perceptions about the amenability of the judge or jury pool to deciding in favor of a particular argument or party.

Moreover, lawyers and parties are often presented with the task of identifying the relevant legal issues at the commencement of a legal proceeding, when information about the judge, evidence, or potential jury is minimal or potentially non-existent. When such assessments are made, they are often costly, requiring a lawyer to, for example, survey dozens of recent legal decisions from a particular judge and/or court that address a particular legal issue. Once that assessment is made, a lawyer or party will often have to select which arguments to emphasize or present and will have to do so based on a laborious process based at least in large part on human judgment. The accuracy of that human judgment will vary significantly with the level of experience brought to bear on the problem by a given lawyer.

Thus, even when there exist experienced lawyers that are able to make judgments about the likelihood of legal events, each experienced lawyer may have significantly different views of the probabilities at issue, making the assessments difficult to compare from lawyer to lawyer. Parties to litigation that face recurring legal issues will have to rely on these difficult-to-compare, subjective assessments to make decisions about the legal proceeding, including what counsel to hire, whether to settle the case, and how much of an accounting reserve is required during the pendency of the litigation.

In some cases where quantitative methods have been employed to assess the likelihood of legal events, such as a favorable outcome on a dispositive motion in litigation, human judgment has been required to quantitatively encode attributes about past data, such as a judge's affinity towards certain arguments or political leanings. These methods have been of limited value to lawyers and parties to legal proceedings because they are generally too inaccurate to provide guidance as to legal strategy. Moreover, existing statistical methods often require the laborious and costly encoding of textual information by humans. In addition, the statistical methods (e.g., multiple regressions) used to evaluate data about legal cases are often incapable of processing multi-dimensional data with precision and cannot accurately model non-linear data patterns. Parties to legal proceedings thus often have little choice but to employ costly legal counsel and to rely on subjective opinions form legal experts that are difficult, if not impossible, to evaluate ex ante for reliability, accuracy, and consistency.

### SUMMARY

This document describes methods, computer program products, and/or systems for assessing the likelihood of legal events, such as, without limitation, success or failure on a dispositive motion, a successful appeal before a judicial panel, or a verdict before a jury. Machine-learning algorithms, such as deep neural networks, are configured for internalizing massive amounts of data and making experiential judgments akin to those made by practitioners with decades of experience. Once a machine-learning algorithm is trained, it can make such judgments at scale, where historically a human-intensive process has been required to make subjective judgments about outcomes of legal proceedings.

In some aspects, a method of predicting an outcome of one or more legal events, and generating a confidence score for the predicted outcome using a machine-learning algorithm, can be executed by one or more processors. The method includes the steps of receiving textual input containing natural language from a corpus of documents, and converting the textual input from each document in the corpus of documents into a numerical matrix corresponding to a vocabulary of words and/or phrases that appear in the corpus of documents. The method can further include steps of creating a map of outcomes of at least one of the one or more legal events to each individual document in the corpus of documents, and training one or more machine-learning algorithms to predict an outcome assigned to each document or document set in the corpus of documents. The method can further include steps of providing a test or validation corpus to each of the one or more machine-learning algorithms as an input to validate and test the one or more machine-learning algorithms and measure an accuracy of each of the one or more machine-learning algorithms' prediction, and providing one or more natural language documents to the trained machine-learning algorithm and receive a confidence score for the outcome of at least one of the one or more legal events. Finally, the method can include a step of displaying the confidence score for each legal event on a graphical user interface or in a written report.

In other aspects, the method described above can be executed by a system, such as a computing system of one or more computers and/or computer processors, or by a computer program product, each of which can include one or more processors, storage media, and one or more programs stored in the storage media for execution by the one or more processors, the one or more programs comprising instructions for executing the method described above.

The benefit of providing machine-learning algorithms, such as deep architectures of artificial neural networks, with natural language input is that human judgment is minimized during the prediction process, and the marginal cost of evaluating a legal event is small once a machine-learning algorithm has been trained on past data. Moreover, subjective human judgments about the meaning of language in the unstructured documents are largely eliminated. Critically, a machine-learning algorithm can internalize thousands, if not tens of thousands of data points from the past, whereas even the most highly skilled legal professional may be hard pressed to recall more than several dozen past legal precedents when evaluating a case. Likewise, a machine-learning algorithm, such as a deep neural network, can process thousands of pages of unstructured natural language in minutes, if not seconds, where as a legal professional may require weeks or months to review all of the documents involved in a legal proceeding. Once processed, deep neural networks can make expert judgments about legal issues that historically have required years of training for a human to perform. For example, a trained model may be able to assess whether a fraud claim has been adequately plead in a complaint (based predominantly on the natural language that appears in the complaint) with greater accuracy and consistency than an experienced lawyer.

The details of one or more implementations are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a block diagram view of an implementation of a system that can generate predictions of outcomes of legal arguments and events using unstructured natural language data;

FIG. 2 is a block diagram showing a machine logic for a Training Sub-system;

FIG. 3. is a flow chart showing a first implementation of a method performed, at least in part, by the Training Sub-system;

FIG. 4. is a flow chart showing a method performed, at least in part, by a Model Application Sub-system;

FIG. 5. is a flow chart showing a first method performed, at least in part, by a UI Sub-system; and

FIG. 6 illustrates an example of an output for a set of securities litigation models.

Like reference symbols in the various drawings indicate like elements.

### DETAILED DESCRIPTION

Implementations of systems and methods described herein use data that include unstructured data such as pleadings, motions, and corpuses of evidence to assess probabilities of outcomes in legal proceedings and particular legal or factual arguments.

Implementations of the present disclosure may be implemented as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the forgoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch cards or raised structures in a groove having instructions recorded thereon and any suitable combination of the foregoing. A computer readable storage medium, as used herein, is not to be construed as being transitory signals per se, such as radio waves or other freely propagating electromagnetic waves, electromagnetic wages propagating through a wave-guide or other transmission media (e.g., light pulses passing through a fiber-optic cable), or electrical signals transmitted through a wire.

Computer readable program instructions described herein can be downloaded to respective computing/processing devices from a non-transitory, computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the networks and forwards the computer readable program instructions for storage in a computer readable storage medium within the respective computing/processing device.

Computer readable program instructions for carrying out operations described herein may be assembler instructions, instruction-set-architecture (ISA) instructions, machine instructions, machine dependent instructions, microcode, firmware instructions, state-setting data, or either source code or object code written in any combinations of one or more programing language, including an object oriented programming language such as C++ or Python, and conventional procedural programming languages, such as the “C” programing language or similar programing languages. The computer readable program instructions may execute entirely on the user's computer, partly on the user's computer, as a stand-alone software package, partly on the user's computer, and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects described herein.

Aspects of the present disclosure are described herein with reference to flowchart illustrations and/or block diagrams of methods, apparatus (systems), and computer program products according to implementations described herein. It will be understood that each block of the flowchart illustrations and/or block diagrams, and combinations of blocks in the flowchart illustrations and/or block diagrams, can be implemented by computer readable program instructions.

These computer readable program instructions may be provided to a processor or a plurality of processors of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such as the instructions which execute on the computer, other programmable apparatus, or other device implement the functions/acts specified in the flow-chart and/or block diagram block or blocks.

The flowchart and block diagrams in the figures illustrate the architecture, functionality, and operation of possible implementations of systems, methods, and computer program products according to various implementations described herein. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustrations, can be implemented by special purpose hardware-based systems that perform specified functions or acts or carry out combinations of special purpose hardware and computer instructions. For example, a machine-learning algorithm may be trained using one or more graphical processing units (GPU) or vector processing units.

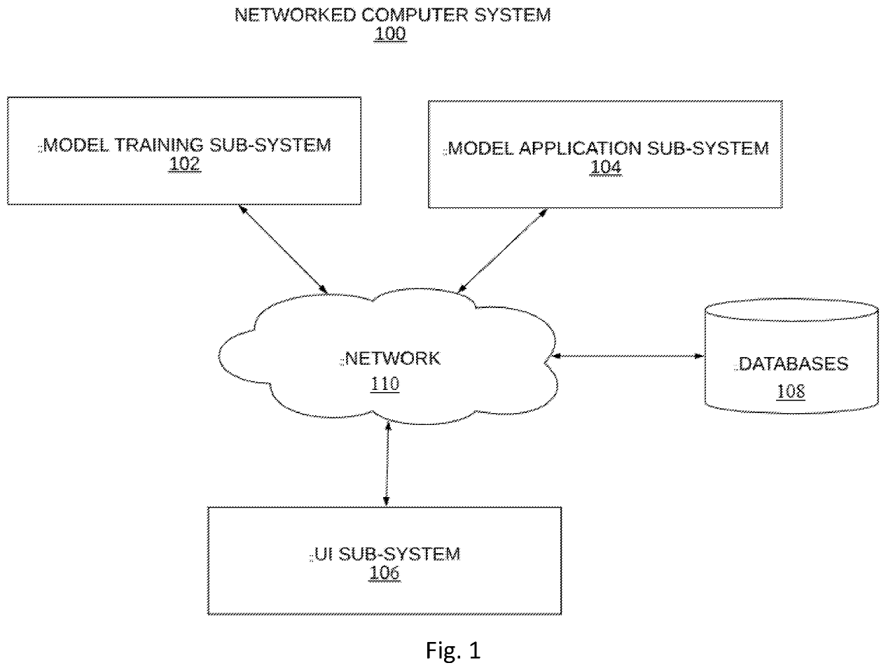

An implementation of a hardware and software environment for software and/or methods according to the implementations presented herein will now be described in detail with reference to the figures. FIG. 1 is a functional block diagram illustrating various portions of networked computer system 100, including: a model training sub-system (the “Training Sub-system”) 102, a model application subsystem (the “Model Application Sub-system”) 104, and a user interface subsystem (the “UI Sub-system”) 106.

Training Sub-system 102 is, in many respects, representative of the various computer sub-system(s) in the exemplary implementation (including, for example, sub-systems 104 and 106). Accordingly, several portions of Training Sub-system 102 will now be discussed in the following paragraphs. Many of the same components may be used to implement sub-systems 104 and 106.

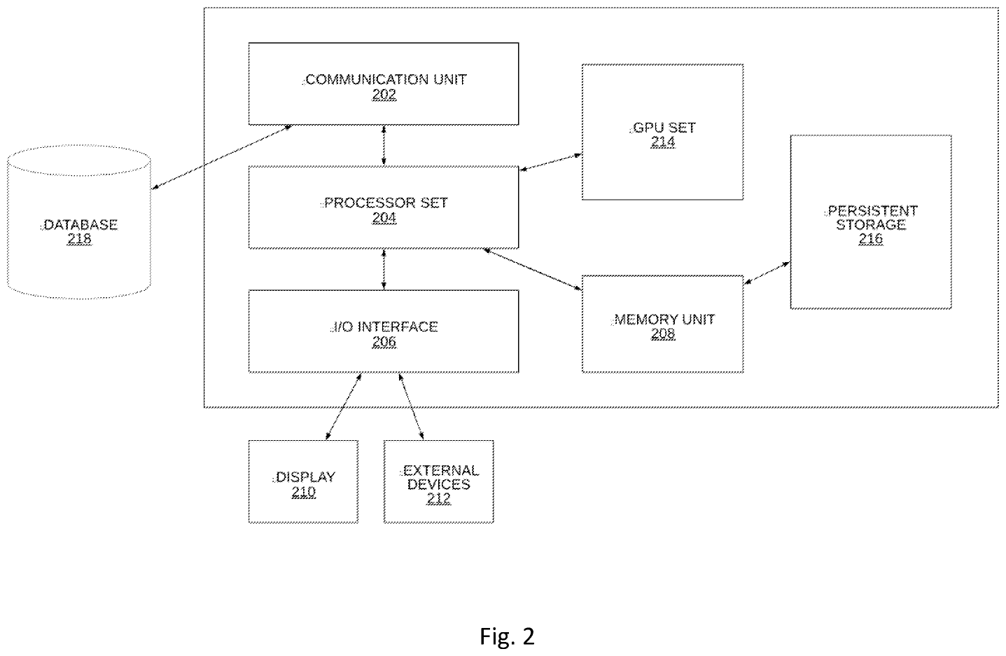

Training Sub-system 102 may be one or more personal computers (PC), mainframes, servers, laptop PCs, or one or more of any other programmable electronic devices capable of communicating with a database 108 or any of the other sub-systems (e.g., 104 and 106) via network 110. In some implementations, the Training Sub-system 102 may be one or more servers connected to a plurality of GPUs capable of performing vector mathematical operations required for training machine-learning algorithms at higher speeds than at present possible for conventional general-purpose processors. FIG. 2 depicts the hardware configuration required for such an implementation. In the example implementation described herein, one or more GPUs in GPU set 214 are connected to a central processing unit (CPU) in processor set 204, which is connected to memory unit 208, persistent storage device 216, and communications unit 202. Although in the exemplary implementation, the processor set communicates with the GPU set locally (i.e., through a system communications bus), in certain implementations, the CPU may communicate with the GPU through communication unit 202.

In some implementations, Training Subsystem 102 reads unstructured documents and other data from a database 218, which in some implementations may be stored on a remote computer or server with which Training Sub-system 102 will communicate through the communication unit 202. In one implementation, the database 218 can be the same as the database 108. Training Sub-system 102 also stores the models it has trained in a separate model database in database set 218 that is accessible by the Model Application Sub-system 104. Databases, including those that are part of database set 218, may be implemented through a number of existing database technologies, including in a relational databases, such as MySQL®, No-SQL databases, such as MongoDB®, or using distributed database systems. In some implementations, databases may be stored locally on Training Sub-system's 102 persistent storage device(s) 216 or other computer-readable storage media.

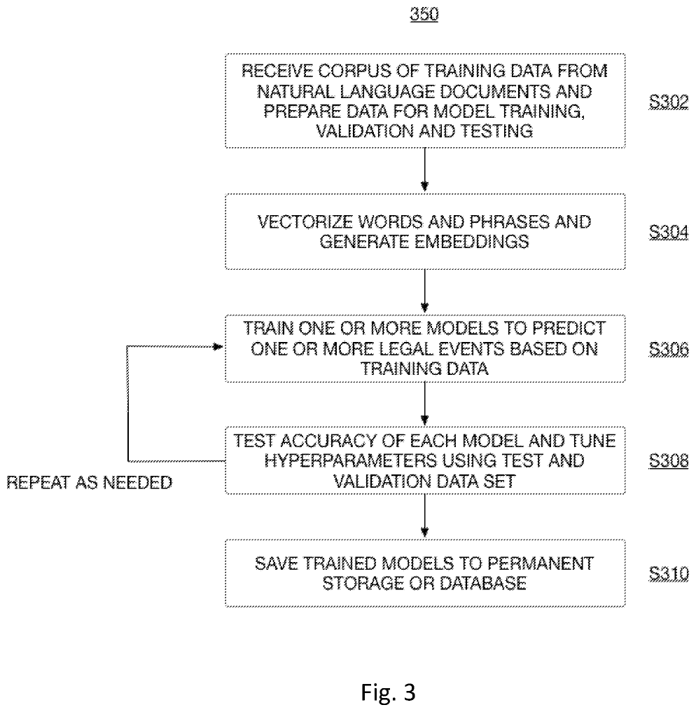

The methods depicted in FIGS. 3, 4 and 5 may be in the form of machine readable and performable instructions and/or substantive data (that is, the type of data stored in databases). In this particular implementation, persistent storage 216 includes a solid-state hard disk drive. To name some possible variations, persistent permanent storage includes magnetic hard disk drives, read-only memory (ROM), erasable programmable read-only memory (EPROM), flash memory, or any other computer-readable storage media that is capable of storing program instructions or digital information.

Memory unit 208 and persistent storage 216 are computer readable storage media. In general, memory can include any suitable volatile or non-volatile computer-readable storage-media. It is further noted that: (i) external device(s) can supply some or all of memory unit 208 for Training Sub-System 102; and/or (ii) devices external to sub-system can provide memory 208 for Training Sub-System 102.

The media used by persistent storage may also be removable. For example, a removable hard drive may be used for persistent storage 216. Other examples include optical and magnetic disks, thumb drives, and smart cards that are inserted into a drive for transfer onto another computer-readable storage medium that is also part of persistent storage 216.

Communication unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 216) through a communications unit (such as communications unit 202).

I/O interface set 206 allows for input and output of data with other devices that may be connected locally in data communication with the Training Sub-system 102. For example, I/O interface set 206 provides a connection to external device set 212. External device set 212 will typically include devices such as keyboard, keypad, a touch screen, and/or some other suitable input device. External device set 212 can also include portable computer-readable storage media such as, for example, thumb drives, portable optical or magnetic disks, and memory cards. Software and data used to practice implementations described herein can be stored on such portable computer-readable storage media. In these implementations the relevant software may (or may not) be loaded, in whole or in part, onto persistent storage device 216 via I/O interface set 206. I/O interface set 206 also connects in data communication with display device. In some implementations, I/O interface 206 also connects in data communication to a remote computer using a user-interface shell, such as a Bash shell connected through a secure shell connection, through which a user can remotely provide input and obtain output from Training Sub-system 102.

Display device 210 provides a mechanism to display data to a user and may be, for example, a computer monitor or smart phone display screen.

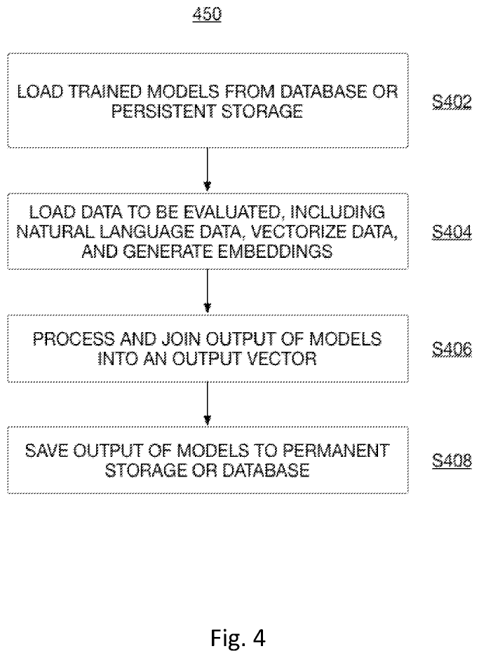

In some exemplary implementations, Model Application Sub-system 104 may utilize similar hardware and software as described for Training Sub-system 102, including one or more CPUs, one or GPUs, memory, persistent storage, communications unit, I/O interface set, and display device. Model Application Sub-system may also access one or more databases, implemented with the same technology as the database(s) 218 used in Training Sub-system 102. In the present example, Model Application Sub-system reads machine-learning models stored in database 218 before applying the steps set forth in FIG. 4. In some implementations, pre-trained machine-learning models may be stored onto a specially configured Computer (see the definition of “Computer,” in the Definitions sub-section of this Detailed Description) or hardware device rather than a Computer containing a general-purpose CPU.

UI sub-system 106 may also rely on substantially similar hardware and software technology described for Training Sub-system 102 and Model Application Sub-system 104. In some implementations, the I/O interface set in UI Sub-system 106 communicates with a web server, which formats and displays relevant output to a user on a remote computer or device running a web browser. In such implementations, a display device may not be necessary, as all I/O will be displayed on remote computers accessing the I/O interface set via data transmitted through a web server. In addition, in some implementations, one or more GPUs may not be necessary, as calculations to be performed by the UI Sub-system may not require a large number of vector operations as in the case when a machine-learning model is being trained or applied to data.

The programs described herein are identified based upon the application for which they are implemented in a specific implementation described herein. However, it should be appreciated that any particular program nomenclature herein is used merely for convenience, and thus the implementations described herein should not be limited to use solely in any specific application identified and/or implied by such nomenclature.

The descriptions of the various implementations described herein have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

To summarize the example implementation described in this section, one or more models are trained to predict one or a plurality of legal events by Training Sub-system 102, which saves the trained models to a database. The models are later loaded by Model-Application Sub-system 104 from a database to determine probabilities of a set of selected legal events given a particular input of legal documents and other data, which includes vectorized natural language data. Finally, a report containing the probabilities is generated and displayed by UI Sub-system 106. For example, a model may be trained to take a complaint in a securities lawsuit as input and to determine the probabilities of granular legal arguments prevailing on a motion to dismiss, such as failure to plead with particularity, loss causation, materiality, or falsity. Once trained using a corpus of complaints in a training dataset, any given securities complaint can then be evaluated by the trained machine-learning algorithm corresponding to each legal argument/issue, and the resulting probability/confidence score outputs can then be displayed by the UI Sub-system as a report of probabilities corresponding to the success or failure of each legal argument. Each of the sub-systems used as part of the example implementation are further described in detail below.

FIG. 3 is a flowchart of a method 350 corresponding to the function of the Training Sub-system. Specifically, FIG. 3 shows a flowchart describing the method used by Training Sub-system to (i) train one or more machine-learning models to identify the probability of success for a legal argument or legal event using input data containing, inter alia, unstructured text from legal documents and pleadings, (ii) test and validate the trained model(s), and (iii) store one or more trained models to persistent storage or a database. Processing begins at step S302, during which I/O module of the Training Sub-system receives a corpus of unstructured text in documents that are precursors to legal events, such as a complaint filed prior to a motion to dismiss the complaint. The/VO module then receives a plurality of legal documents containing natural language or other unstructured text, and analyzes the words and phrases that occur throughout the entire corpus of documents to determine a vocabulary of words and phrases that occur. In some implementations, the unstructured data is merged with one or more structured forms of data, such as an assigned judge or jury pool. During S302, the data, both structured and unstructured, is mapped to outcomes to be predicted by the machine-learning model. For example, a complaint is mapped to a value indicating the outcome of a particular argument on a motion to dismiss, such as a dismissal of a securities complaint for failure to plead loss causation. A subset of the corpus of data that is assembled is set aside for testing and validation and is not used to train the machine-learning models.

The unstructured text is processed at S304 by converting the words and phrases in the legal document into tokens or vectors. In some implementations, words and phrases may be vectorized, mapping words or phrases into a vector space, such that related words and phrases are geometrically adjacent in the vector space. Mapping words and phrases into a continuous vector space allows comparison of meaning through numerical methods, such as vector operations, that can be performed by a computer or special purpose processor such as a GPU. In some implementations, images of each page of a document may be vectorized and concatenated with the vectorized and/or tokenized text.

In some implementations, the tokenized words and phrases are fed into an embedded layer of artificial neurons for vectorization. The embedded layer executes instructions to learn relations between the words and phrases as a precursor to processing by other machine-learning algorithms, such as deep-architectures of neural networks. In some implementations, a plurality of legal documents other than those in the training set may be used to pre-train an embedded layer to provide the model with a vector space derivation that is based on the syntax and vocabulary used frequently in legal documents, such as pleadings and court opinions. For example, in some implementations, an embedded layer may be pre-trained using a plurality of un-annotated legal opinions. The pre-trained embedded layer is in such implementations then frozen and used as a threshold layer for the model that determines the probability of a legal event. Because in some cases there is likely parity between the vector space derived from the embedded layer trained on the un-annotated legal documents and the input data for the predictive model, transfer learning occurs, thereby increasing the efficacy of a given model's ability to process natural language.

In the exemplary implementation, the vectorized words and phrases are passed on in S306 to be processed by a plurality of layers of artificial neurons with each layer passing through a rectified linear unit (ReLu) activation function. In some implementations, one or more of the layers of artificial neurons will be convolutional neural networks or inception layers of convolutional neural networks, capable of summarizing patterns in the unstructured data before further processing. Some implementations can include one or more layers of recurrent neural networks (RNN), including Long Short-Term Memory layers (LSTM). Moreover, some implementations can contain one or more layers of fully connected neural networks layers, and some of these layers may contain feedback connections, such as residual connections, which provide for propagation of input signals to subsequent layers. Doing so, inter alia, allows deeper networks to be trained using back propagation without floating-point and other computational errors that typically result from diminishing or vanishing cost-function/model-weight gradients.

In the exemplary implementation, the output of the plurality of layers of artificial neural networks can be routed through a sigmoid activation function, which maps the output of the series of neural networks to a real number between 0 and 1, inclusive, denoting a probability of the legal outcome being modeled. In some exemplary implementations, the output can be routed through one or more activation function, such as a rectified linear unit (ReLu) or a Tan h activation function, before being normalized into a confidence score or probability value.

In other implementations, the output may be used for classification, with score thresholds above some value corresponding to a classification corresponding to a legal event. For example, a securities lawsuit may fail for failure to adequately plead a requisite level of intent (i.e., scienter) or may not state an actionable claim for scienter as plead in a legal document. In such an example, the output values of the plurality of layers of artificial neurons could be compared to threshold values, indicating the legal argument will fail for one of the categories of reasons (e.g., failure to plead scienter with particularity vs. failure to plead scienter as a matter of law). In some implementations, the output of the model may be a generative neural network or a recurrent neural network that is designed to generate the text of a legal document or pleading. In such implementations, the output will be a sequence of text that corresponds to the probability of a legal event.

In the exemplary implementation, each model is tested and tuned at S308 for accuracy using one or more testing and validation sets. In some implementations, a percentage accuracy is determined for the testing and validation sets. In some implementations, a k-fold cross-validation system may be used to verify model accuracy and to tune hyper-parameters. In some models, a separate validation set may be used to tune hyper-parameters for the machine-learning model(s), and a separate testing dataset may be used to determine model accuracy and whether the model is capable of generalizing on data outside of the sample it was trained on.

In the present implementation, models are trained using a back propagation algorithm. Specifically, models in the present implementation are trained using the Adam optimizer, which is a first-order gradient-based algorithm that optimizes a stochastic optimization function, with an adaptive learning rate and momentum. In some implementations, models may be trained using another gradient-based optimizer algorithm, such as the Stochastic Gradient Descent, AdaGrad, or RMSProp algorithms.

At S310, one or more trained models are saved to a database or persistent storage to be retrieved and applied by the Model Application Sub-system 104. In some exemplary implementations, the vectorization model or embedded layer created for the document corpus used to train a particular model may also be saved with the model to be applied to data being provided to the Model Application Sub-system 104.

FIG. 4 describes a method corresponding to the function of the Model Application Sub-system. Specifically, FIG. 4 shows flowchart 450 of a method used by Model Application 104 subsystem to (i) load one or more pre-trained machine-learning models, and (ii) generate a vector of probability outputs from one or more loaded model, with each component of the vector output corresponding to the probability of a legal event. In some implementations, the output will be a vector of category classifications corresponding to particular categories of legal events.

The Model Application Sub-system 104 loads the models at S402 from a database or from persistent storage. In some implementations, the database can be shared with the Model Training Sub-system. Moreover, in some implementations, the models are selected using a configuration file, such as a file encoded in raw text, JavaScript Object Notation (JSON) or XML format, indicating the set of legal events to test using unstructured or natural language data input. For example, a configuration file can instruct the Model Application Sub-system to select models that predict probabilities for a plurality of legal arguments to dismiss a securities complaint, (e.g., adequacy of pleading, scienter, loss causation).

At S404, the Model Application Sub-system 104 loads the unstructured data to be evaluated by the loaded machine-learning models. The unstructured text data is vectorized in accordance with the vectorization that occurred during the training of the corresponding models that were loaded in S402. In some implementations, the vectorization model or embedded layers can be loaded with the machine-learning model and used to encode the data to be evaluated. In certain implementations, the unstructured data to be tested can be joined or concatenated with structured data, such an assigned judge. In some implementations, some of the data joined or concatenated with the unstructured data may be hypothetical—e.g., versions of the same complaint will be paired with a plurality of judges to reflect hypothetical probabilities corresponding with the assignment of each judge to decide a motion to dismiss one or more claims asserted in the complaint or the complaint itself.

Processing proceeds to step S406, during which the output of each of the loaded pre-trained models is joined or concatenated into a single vector. In the exemplary implementation, the generated vector can consist of one or more probabilities associated with the selected set of legal events. For example, each component of the output vector will correspond to a particular legal argument prevailing on a motion to dismiss. In the exemplary implementation, the generated vector will contain one or more probabilities on a scale of probabilities, such as ranging from 0 to 1, indicating the likelihood of a particular legal event occurring. In certain implementations, the output vector may contain one or more real or integer numbers corresponding to various classifications of legal events. In certain implementations, the Model Application Sub-system 104 may make a macro prediction based on a collection of legal events that some macroscopic event will or will not occur (e.g., an entire case being dismissed or a favorable judgment at some point in the future). The output vectors may then be saved to persistent storage or a database S408, which can be accessed by the UI Sub-system.

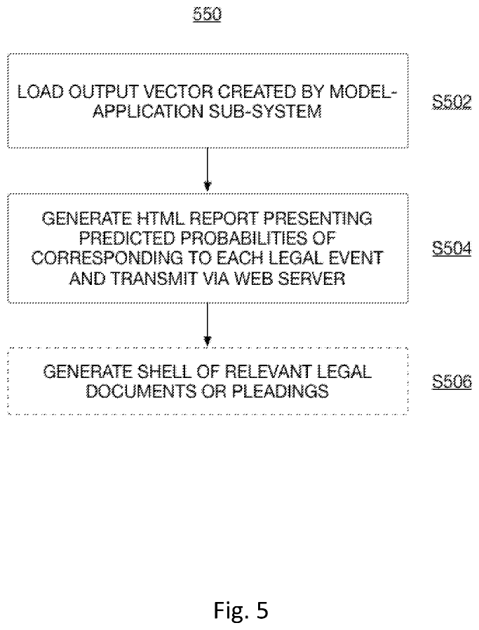

FIG. 5 is a flowchart illustrating a method corresponding to the function of the Model Application Sub-system 104. The model UI Sub-system 106 loads the output vector from the Model Application Sub-system 104 at S502. In an exemplary implementation, the output corresponding to each predicted legal event is formatted and displayed to a user through a web-server. At S504, the output is generated html displaying probability or confidence scores for each predicted legal event that may arise from the input legal document or other unstructured data or corpus of data. In some implementations, the output may be presented as a confidence score, a letter grade, a percentage, or means or system of expressing confidence or probability that a particular legal event will or will not occur (e.g., a securities claim being dismissed for failure to plead with particularity). In some implementations, the UI Subsystem 106 can be configured to present the output of the model(s) in graphical form or provide a comparison to other similar inputs provided to the models (e.g., such as other complaints filed in the same jurisdiction). In certain implementations, processing will proceed to S506, during which a legal document, such as a legal brief, is generated, and which may include a skeletal draft of the relevant arguments to be presented or the relevant legal standards or arguments corresponding to each predicted legal event.

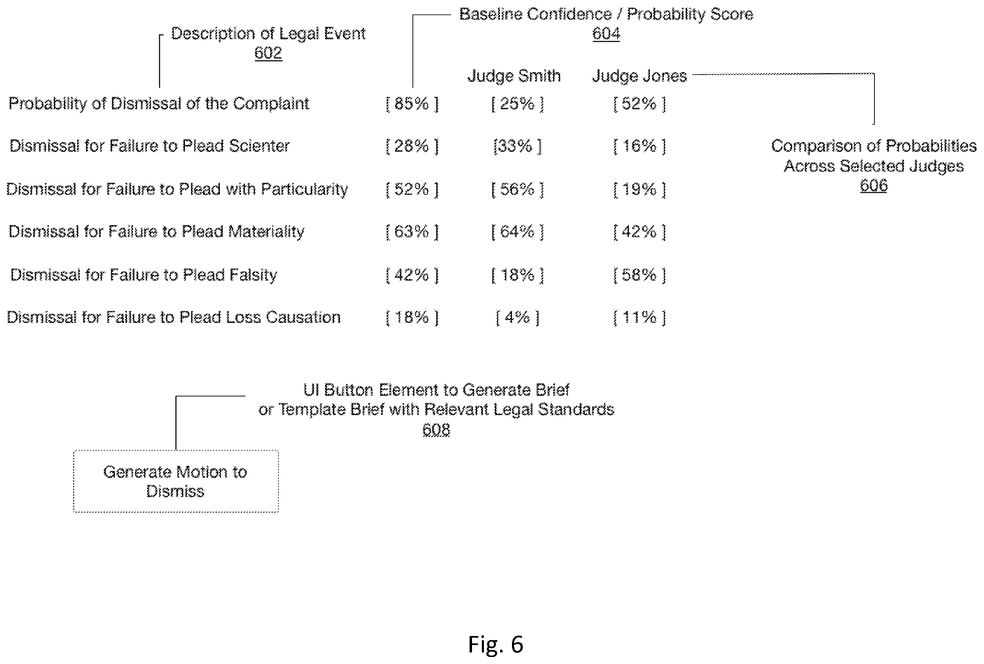

FIG. 6 shows an example of an output for a set of securities litigation models. Specifically, FIG. 6 is an example display of a motion to dismiss probability report for a given securities complaint. In some implementations, the output may, for example, contain a description of each legal event evaluated by the set of models 602, a baseline probability for each legal event across all judges in a particular jurisdiction 604, a comparison of probabilities for each legal event among a plurality of judges 606, and a UI element (e.g., button) that causes the UI Sub-system to generate a legal brief or pleading 608.

In certain implementations, the machine-learning algorithm used will not consist of, or consist solely of, a series of layers of artificial neural networks. Other machine-learning algorithms alone or in combination may also be used to generate predictions of legal outcomes. These algorithms include, for example, support vector machines (SVM).

In addition, certain implementations may be designed to provide predictions of classifications of a broad range of legal events based on a given legal document or set of legal documents. For example, the predicted legal event may be the outcome of motions, jury votes at trial, votes of appellate court judges hearing an appeal, the invalidation of a patent, the outcome of a motion for a preliminary injunction, the decision of an administrative law judge, or even the commencement of a lawsuit.

Moreover, although the document provided as an input may be a legal pleading, such as a complaint, the input may include a corpus or set of documents, such as a set of documents to be entered into evidence, an expert report, briefing, a patent, a contract, or any combination of such documents. The machine-learning algorithm(s) are capable of mapping a set of such unstructured natural language documents (alone or in conjunction with structured information, such as an assigned judge) to probabilities corresponding to particular legal outcomes (e.g., dismissal at summary judgment, a successful appeal, or a unanimous jury verdict).

The following definitions are applicable to this disclosure:

And/or: inclusive or; for example, A, B “and/or” C means that at least one of A or B or C is true and applicable.

Including/include/includes: unless otherwise explicitly noted, means, “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devise, smart phones, personal digital assistants (PDAs), body-mounted or inserted computers, embedded device style computers, application-specific integrated circuit (ASIC) based devices.

Natural Language: any language used by human beings to communicate with each other.

Natural Language Processing: any derivation of meaning from natural language performed by a computer.

Tokenize: the conversion of words or phrases into numerical tokens using a computer program.

Vectorize: the conversion of words or phrases in natural language into vectors, wherein the components of the vector map the word or phrase into a continuous vector space, allowing the words or phrases to be compared using numerical methods or processed by a machine-learning algorithm.

Although a few implementations have been described in detail above, other modifications are possible. Other implementations may be within the scope of the following claims.

1. A computer-implemented method of predicting an outcome of one or more legal events, and generating a confidence or probability score for the predicted outcome using a machine-learning algorithm, the method comprising:
receiving, by one or more data processors, textual input containing natural language from a corpus of documents;
converting, by one or more data processors, the textual input from each document in the corpus of documents into a numerical matrix corresponding to a vocabulary of at least one of words and phrases that appear in the corpus of documents;
creating, by one or more data processors, a map of outcomes of at least one of the one or more legal events to each individual document in the corpus of documents;
training, by one or more data processors, one or more machine-learning algorithms to predict an outcome assigned to each document or document set in the corpus of documents;
providing, by one or more data processors, a test or validation corpus to each of the one or more machine-learning algorithms as an input to validate and test the one or more machine-learning algorithms and measure an accuracy of the prediction by each of the one or more machine-learning algorithms;
providing, by one or more data processors, one or more natural language documents to the trained machine-learning algorithm and receiving a confidence score for the outcome of at least one of the one or more legal events; and
displaying, by one or more data processors, the confidence score for each legal event on a graphical user interface or in a written report.

2. The method of claim 1, wherein the machine-learning algorithm includes:
one or more layers of artificial neural networks that are connected in parallel or in series, resulting in an output a numerical score associated with a single or plurality of outcomes of legal events.

3. The method of claim 1, wherein the machine-learning algorithm includes:
one or more layers of convolutional neural networks that are connected in parallel or in series, resulting in an output a numerical score associated with a single or plurality of outcomes of legal events.

4. The method of claim 1, wherein the machine-learning algorithm includes:
one or more layers recurrent neural networks that are connected in parallel or in series, resulting in an output a numerical score associated with a single or plurality of outcomes of legal events.

5. The method of claim 1, wherein the machine-learning algorithm includes:
one or more inception layers that are connected in parallel or in series, resulting in an output a numerical score associated with a single or plurality of outcomes of legal events.

6. The method of claim 1, wherein the machine-learning algorithm includes:
one or more support vector machines that are connected in parallel or in series with each other or other machine-learning algorithms, resulting in an output a numerical confidence score associated with a single or plurality of outcomes of legal events.

7. The method of claim 1, wherein the textual input from each document in the corpus is converted into a numerical matrix using an embedded layer of artificial neurons.

8. The method of claim 1, wherein the textual input from each document in the corpus is converted into a numerical matrix using a tokenizer that associates a given word or phrase appearing in the corpus to a numerical value or vector of numerical values.

9. The method of claim 1, wherein the confidence score produced is a number reflecting the probability of a positive or negative outcome for a legal argument or issue ranging from a scaled factor of a real number that ranges from 0 to 1.

10. The method of claim 1, wherein the output produced is a real number indicating the degree of confidence that one or more legal events will or will not occur.

11. The method of claim 1, wherein the output is used to generate legal documents or pleadings containing relevant arguments or legal standards.

12. The method of claim 8, further comprising generating, by one or more processors, legal documents or pleadings containing at least one of relevant arguments and relevant legal standards based on the outcome and the confidence score.

13. A computer system for predicting the outcome of legal events and generating a confidence or probability score for the predicted outcome using a machine learning algorithm, the computer system comprising:
one or more processors;
storage media; and
one or more programs stored in the storage media for execution by the one or more processors, the one or more programs comprising instructions for:
receiving textual input containing natural language from a corpus of documents;
converting the textual input from each document in the corpus of documents into a numerical matrix corresponding to a vocabulary of words and/or phrases that appear in the corpus of documents;
creating a map of outcomes of at least one of the one or more legal events to each individual document in the corpus of documents;
training one or more machine-learning algorithms to predict an outcome assigned to each document or document set in the corpus of documents;
providing a test or validation corpus to each of the one or more machine-learning algorithms as an input to validate and test the one or more machine-learning algorithms and measure the accuracy of each of the one or more machine-learning algorithms' prediction;
providing one or more natural language documents to the trained machine-learning algorithm and receiving a confidence score or probability value for the outcome of at least one of the one or more legal events; and
displaying the confidence score for each legal event on a graphical user interface or in a written report.

14. The computing system of claim 13, wherein the machine-learning algorithm includes:
one or more layers of artificial neural networks that are connected in parallel or in series, resulting in an output a numerical score or probability value associated with a single or plurality of outcomes of legal events.

15. The computing system of claim 13, wherein the machine-learning algorithm includes:
one or more layers of convolutional neural networks that are connected in parallel or in series, resulting in an output a numerical score or probability value associated with a single or plurality of outcomes of legal events.

16. The computing system of claim 13, wherein the machine-learning algorithm includes:
one or more layers of recurrent neural networks that are connected in parallel or in series, resulting in an output a numerical score or probability value associated with a single or plurality of outcomes of legal events.

17. The computing system of claim 13, wherein the machine-learning algorithm includes:
one or more inception layers that are connected in parallel or in series, resulting in an output a numerical score or probability value associated with a single or plurality of outcomes of legal events.

18. The computing system of claim 13, wherein the machine-learning algorithm includes:
one or more support vector machines that are connected in parallel or in series with each other or other machine-learning algorithms, resulting in an output a numerical score or probability value associated with a single or plurality of outcomes of legal events.

19. The computing system of claim 13, wherein the textual input from each document in the corpus is converted into a numerical matrix using an embedded layer that associates a given word or phrase appearing in the corpus to a numerical value or vector of numerical values.

20. The computing system of claim 13, wherein the textual input from each document in the corpus is converted into a numerical matrix using a tokenizer that associates a given word or phrase appearing in the corpus to a numerical value or vector of numerical values.

21. The computing system of claim 13, wherein the confidence score produced is a number reflecting the probability of a positive or negative outcome for a legal event ranging from a scaled factor of a real number that ranges from 0 to 1.

22. The computing system of claim 13, wherein the output produced is a real number indicating the degree of confidence that one or more legal events will or will not occur.

23. The computing system of claim 13, wherein the instructions include instructions to generate legal documents or pleadings containing relevant arguments or legal standards based on the output.

24. The computing system of claim 13, wherein the one or more programs comprise further instructions for using one or more generative neural networks to generate legal documents or pleadings containing relevant arguments or legal standards based on the output.
